(19) United States
(12) Patent Application Publication
(10) Pub. No.: US 2008/0165361 A1
(43) Pub. Date: Jul. 10, 2008

(54) METHOD OF ANALYZING SULFUR CONTENT IN FUELS

(76) Inventor: Robert E. Kauffman, Centerville, OH (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/969,623

(22) Filed: Jan. 4, 2008

Related U.S. Application Data
(60) Provisional application No. 60/878,950, filed on Jan. 5, 2007.

(51) Int. Cl. G01J 3/46; G01N 30/74

(52) U.S. Cl. 356/402; 73/61.61

(57) ABSTRACT

A method of detecting the amount of sulfur compounds in fuels such as ultra low sulfur diesel (ULSD) fuels is provided in which a fuel sample is reacted with a solvent and an oxidizing agent to produce a reaction product which may be analyzed by visual observation and/or in combination with spectrophotometric or colorimetric analysis. The oxidizing agent may be selected from potassium permanganate, sodium dichromate, nitric acid, hydrogen peroxide, cumene hydroperoxide, and sodium hypochlorite, and may be used in combination with an acid.

### CROSS-REFERENCE TO RELATED APPLICATIONS

This application claims the benefit of U.S. Provisional Application No. 60/878,950, filed Jan. 5, 2007, entitled COLORIMETRIC SCREENING TEST FOR ULSD FUELS. The entire contents of said application are hereby incorporated by reference.

### BACKGROUND OF THE INVENTION

Embodiments of the present invention relate to methods of detecting sulfur compounds in fuels, and more particularly, to a method which utilizes a mixture of a fuel sample, solvent, and oxidizing agent in combination with visual observation and/or spectrophotometric or colorimetric analysis to detect the amount of sulfur compounds in fuels such as ultra low sulfur diesel (ULSD) fuels and other sulfur containing liquids, all of which are referred to herein as “fuels.”

In recent years, the EPA has implemented stringent emission standards for diesel engines and fuels. Most recently, in October 2006, the EPA mandated the use of ultra low sulfur diesel (ULSD) fuels which contain less than 15 ppm sulfur. The new regulation applies to all diesel fuel, diesel fuel additives, and distillate fuels blended with diesel for on-road use, such as kerosene. The use of such low sulfur content fuels will enable the use of after-treatment technologies for diesel engines which has the potential to reduce harmful emissions by 90 percent or more. Accordingly, implementation of the new standards should result in long-term public health and environmental benefits.

In conjunction with the ULSD fuel requirement beginning January 2007, all trucks traveling in the U.S. are being randomly checked for compliance with the ULSD requirement. For example, designated state and/or federal employees may sample fuel from the fuel tanks of trucks at weigh stations, truck stops, etc. However, current ASTM methods used for low sulfur determinations are not suitable for on-site, non-technical operation due to their size, the use of radioactive sources and/or fuel combustion, operation time, etc.

Accordingly, there is a need in the art for a simple and portable test for detecting the sulfur content in fuels to determine if the levels of sulfur are in compliance with current EPA regulations.

### SUMMARY

Embodiments of the present invention meet that need by providing a method of determining the sulfur content in fuels such as ULSD fuels which can be performed visually and/or using portable equipment. The method can be used to differentiate between ULSD fuels (fuels containing less than 15 ppm sulfur) and non-ULSD fuels (fuels containing higher than 15 ppm sulfur; e.g. non-transportation diesel fuels, marine fuels and jet fuels contain 300 to 1000 ppm sulfur). The method can also be used to quantitate the sulfur levels of fuels and other liquids down to below 6 ppm sulfur (low detection limit is dependent on the amount of fuel analyzed). The test may be performed quickly (within a few seconds) using a small amount of fuel. The test may be performed, for example, using small vials or test tubes, and may be analyzed visually or quantitatively, for example, using hand-held spectrophotometers which are commercially available or which can be modified for use in the specific analysis.

According to one embodiment of the present invention, a method of detecting the sulfur content of fuels is provided which includes providing a fuel sample; mixing the fuel sample with at least a solvent and an oxidizing agent; and detecting a color change in the mixture. The term “sulfur” as used herein is meant to include elemental sulfur, hydrogen sulfide, organic sulfides, organic disulfides, thiophenes, and the like.

The method may further comprise quantifying the color change. The method may also comprise corresponding the color change with at least one of fuel contamination, oxidation, and sulfur content.

The fuel sample is selected from ultra low sulfur diesel fuel, non-ultra low sulfur diesel fuel, and contaminated low sulfur diesel fuel.

The solvent may be selected from acetone, water, acetonitrile, benzonitrile, ethyl acetate, alcohols, and ketones. The solvent is preferably an acidified solvent, and may include an acid selected from toluenesulfonic acid, phosphoric acid, acetic acid, or a combination thereof. Where the solvent is an acidified solvent, the method preferably further comprises corresponding the color change with at least one of fuel contamination, oxidation, and sulfur content.

Where the solvent is a neutral solvent (i.e., non-acidic), the method preferably further comprises corresponding the color change with at least one of fuel contamination or oxidation.

The oxidizing agent is selected from potassium permanganate, sodium dichromate, nitric acid, hydrogen peroxide, cumene hydroperoxide, and sodium hypochlorite. Preferably, the oxidizing agent comprises potassium permanganate.

The fuel sample used in the method preferably comprises ultra low sulfur diesel fuel, and the method may be used to detect samples containing less than 15 ppm sulfur or greater than 15 ppm sulfur.

In another embodiment of the invention, a method of analyzing the sulfur content in fuels is provided comprising providing a fuel sample; mixing the fuel sample with at least a solvent and an oxidizing agent to form a mixture; and determining whether a color change of the mixture has taken place to determine the sulfur content in the fuel sample. The solvent may further include an acid as described above.

The color change or lack thereof resulting from the reaction of the fuel sample, solvent and oxidizing agent may be determined by visual observation, for example, by visual comparison with a standard colored solution, with the use of a spectrophotometer, or a calorimeter. Where visual observation is used, such observation may include comparison with a standard colored solution or standardized color chart.

In yet another embodiment of the invention, a method of analyzing the sulfur content in fuels is provided comprising providing a fuel sample; providing an amount of an oxidizing agent comprising KMnO₄, adding the oxidizing agent to an acidified solvent to form a mixture; adding the fuel sample to the mixture to form a reaction product; and determining whether a color change of the reaction product has taken place to determine the sulfur content in the fuel sample.

Accordingly, it is a feature of embodiments of the invention to provide methods of quickly analyzing the sulfur content in fuels such as ULSD fuels. Other features and advantages will be apparent from the following description and the accompanying drawings.

### BRIEF DESCRIPTION OF THE DRAWINGS

FIG. 1 is a graph illustrating UV-VIS spectrophotometric spectra of 0, 25 and 50 ppm sulfur standards in kerosene dissolved in acetone containing 1% acetic acid, 1% water and 0.005% potassium permanganate;

FIG. 2 is a graph illustrating VIS spectrophotometric spectra of 0, 25 and 50 ppm sulfur standards in kerosene dissolved in acetone containing 1% acetic acid, 1% water and 0.005% potassium permanganate;

FIG. 3 is a graph showing absorbance at 350 and 528 nm vs. sulfur concentration for 0, 25 and 50 ppm sulfur standards dissolved in acetone containing 1% acetic acid, 1% water and 0.005% potassium permanganate;

FIG. 4 is a graph illustrating integrated absorbance between 450-600 nm vs. sulfur concentration for 0, 12 and 25 ppm sulfur standards dissolved in ethyl acetate containing 1% acetic acid, 1% water and 0.005% potassium permanganate;

FIG. 5 is a graph illustrating UV-VIS spectrophotometric spectra (water layer) of 0 and 50 ppm sulfur standards in kerosene suspended in distilled water containing 0.1% phosphoric acid and 0.005% potassium permanganate; and

FIG. 6 is a graph illustrating integrated absorbance (water layer) vs. sulfur concentration for 0 and 25 ppm sulfur standards suspended in distilled water containing 0.1% phosphoric acid and 0.005% potassium permanganate.

### DETAILED DESCRIPTION OF THE PREFERRED EMBODIMENT

Embodiments of the present invention operate on the basis that sulfur compounds in fuels can be oxidized by specific oxidizing agents and the resulting depletion of the oxidizing agent can be observed visually (via a color change) and/or by the use of spectrophotometric or colorimetric equipment.

The reaction product resulting from the mixing of the fuel sample, oxidizing agent and solvent can be colored or colorless, depending on the oxidizing agent used. For example, the use of oxidizing agents selected from potassium permanganate, sodium dichromate, nitric acid and the like typically produce a colored reaction product, while the use of oxidizing agents selected from hydrogen peroxide, cumene hydroperoxide, sodium hypochlorite and the like typically produce a reaction product whose color is not detectable by visual comparison, but is detectable by spectrophotometric methods.

The use of potassium permanganate (KMnO₄) is preferred for use as an oxidizing agent due to its deep purple color, its solubility in both water and organic solvents, and its tunable reactivity at room temperature. The reactivity of KMnO₄ is strongly affected by the pH of the reaction system and may be used in combination with the following acids: toluenesulfonic acid (pH<1); phosphoric acid (pH=2); and acetic acid (pH=4). The acids may be used either alone or in combination.

Preferred solvents for use in the methods of the present invention are acetone and water; however, other suitable solvents include acetonitrile, benzonitrile, ethyl acetate, alcohols such as methanol, ethanol, and isopropanol, carboxylic acids, and ketones such as methyl ethyl ketone.

In the preferred method of determining sulfur content in fuels, KMnO₄ (used either in solution in water or dry) is added to the acidified solvent (preferably water or acetone containing phosphoric or toluenesulfonic acid ) to produce a purple solution. The fuel sample is then dispensed into the purple solution and shaken for 2-30 seconds. It should be noted that for fuels containing greater than 400 ppm sulfur, the solution decolorizes during shaking. For acetone solutions (fuel soluble, 5 seconds shaking preferred), color differences of the solution can be visually noted or spectrophotometrically measured from about 20 seconds up to 5 minutes. For water suspensions (fuel insoluble, 20 seconds shaking preferred), upon standing, the suspended fuel droplets rise to form a fuel layer on top of the water and color differences in the water layer can be visually noted after 2-30 minutes of standing. If spectrophotometric analysis is used, it should be appreciated that the water solution (without any suspended fuel) must be first transferred into an optical cell.

Regardless of the oxidizing agent used, the procedure is the same except that the wavelength selected from the spectrophotometric analysis should be specific to the oxidizing agent used.

The methods of the present invention can be used to differentiate between ULSD and non-ULSD fuels containing from between about 0-30 ppm sulfur. If the sample is totally discolored during shaking, the fuel sample can be reduced in size and the test repeated to achieve the proper scale since color is linear with sulfur concentration. A visual comparison is sufficient for distinguishing between clean ULSD fuels and non-ULSD fuels or contaminated ULSD fuels (for example, contamination with gasoline, non-ULSD fuel, oxidation gums, hydroperoxides, or carboxylic acids). A colorimeter or spectrophotometer is preferably used if it is desired to quantitate the sulfur levels in ULSD fuels between 0 and 15 ppm or detect sulfur in a non-ULSD fuel to within a few ppm.

In order to visually determine whether the sulfur concentration in fuels is over 15 ppm, the fuel/solvent/oxidizing agent reaction product is compared with a standardized color chart or solution containing vials representing 5, 10, 15, and 20 ppm sulfur or any sulfur concentration range of interest. For example, the reaction product resulting from fuel having from about 50-100 ppm sulfur content is colorless where KMnO₄ is used as the oxidizing agent. The reaction product for fuels having from about 1 to 50 ppm sulfur exhibits shades of purple that lighten with increased sulfur concentration. It is preferred that a colorimeter be used when trying to determine concentrations of fuel samples to within ±2 ppm sulfur.

It should be appreciated that the color range used to make visual determinations of the sulfur content in fuel samples is directly dependent on the oxidizing agent:sulfur (fuel) ratio and the specific oxidizing agent used.

In order that the embodiments of the invention may be more readily understood, reference is made to the following examples which are intended to illustrate the embodiments of the invention, but not limit the scope thereof.

### EXAMPLE 1

Various amounts of methyl phenyl sulfide were added to kerosene (0 ppm sulfur) to produce 0, 12, 25 and 50 ppm sulfur standards for developing a KMnO₄ test for measuring the sulfur concentrations of ULSD fuels (expected to be 15 ppm and below). Two ULSD fuels containing 6 ppm sulfur and two non-ULSD fuels containing 400 ppm sulfur (sulfur concentrations determined by X-ray fluorescence: ASTM D-3120) were also obtained for KMnO₄ test development.

To determine the best wavelength(s) to be used for the spectrophotometric trending of the KMnO₄ depletion resulting from its reaction with natural antioxidants and sulfur compounds contained in ULSD and non-ULSD fuels, the initial tests were conducted in 5 mL glass vials. In each glass vial 0.025 mL of 0.5% KMnO₄ in water, 3 mL of acetone containing 1% acetic acid and 0.25 mL of kerosene sulfur standard were dispensed (in that order). Each vial was then capped and hand shaken for 10 seconds (kerosene soluble in acetone). Color differences were visually noted after 30 seconds: in the 0 ppm sulfur standard solution, no color changes were noted; in the 25 and 50 ppm sulfur standard solutions, the color lightened. The prepared solutions were then poured into a square, quartz cuvette for UV-VIS spectrophotometric analysis.

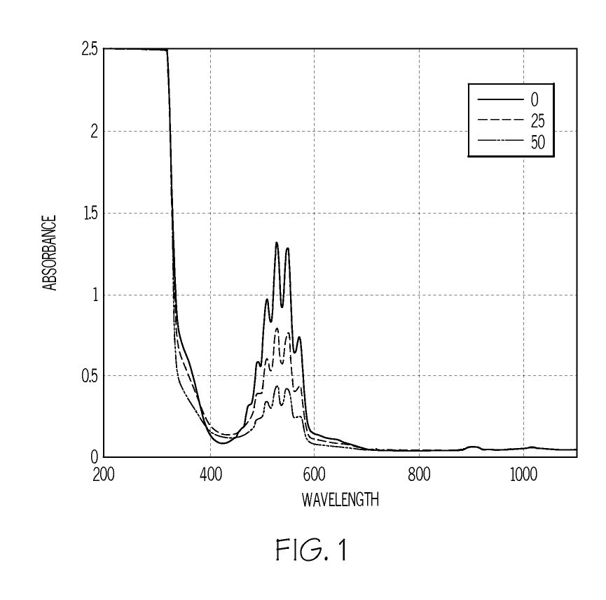

As shown in FIG. 1, the UV-VIS spectra for the 0, 25 and 50 ppm sulfur standards show that the main color absorbance occurs between 400-600 nm (absorbs green, appears red/purple) with a minor color absorbance between 350-400 nm (absorbs blue, appears yellow). It was noted that the 350-400 nm range has the disadvantage of a rising baseline due to acetone absorption of UV light and yellow color from fresh non-ULSD fuels or oxidized ULSD fuels.

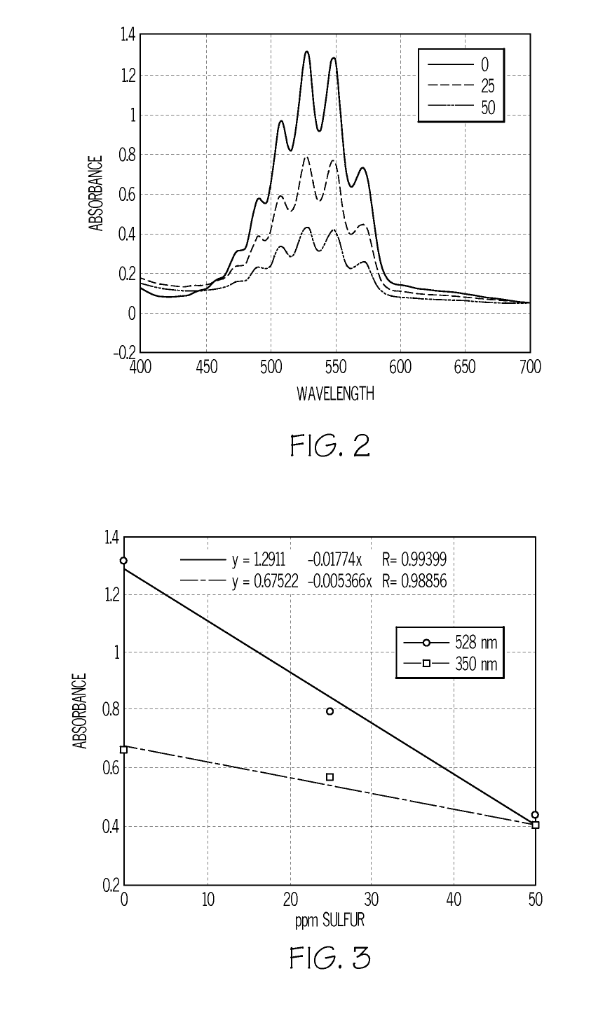

Different green laser diodes and LEDs produce single wavelengths in the 520-550 nm range, making them suitable for development into a single wavelength calorimeter (for example, a single wavelength calorimeter with lines at 528 and 550 nm is commercially available from Hach). As seen in FIG. 2, the two main absorption peaks occur at 528 and 550 in direct correlation with the wavelength outputs of green laser diodes and LEDs. To determine the linearity of the spectrophotometric technique, the absorbances at 350 and 528 nm were plotted versus sulfur concentration for the 0, 25 and 50 ppm standards as shown in FIG. 3. As the absorbance versus sulfur concentration plots show in FIG. 3, the plots are linear for both wavelengths but the 528 nm wavelength (upper line with higher slope) is considered superior to the 350 nm wavelength (lower line with lower slope) for sulfur measurements. The plots in FIG. 3 easily distinguish between 0 and 25 ppm sulfur content and the linearity of the plot indicates that the sensitivity should be below 6 ppm.

### EXAMPLE 2

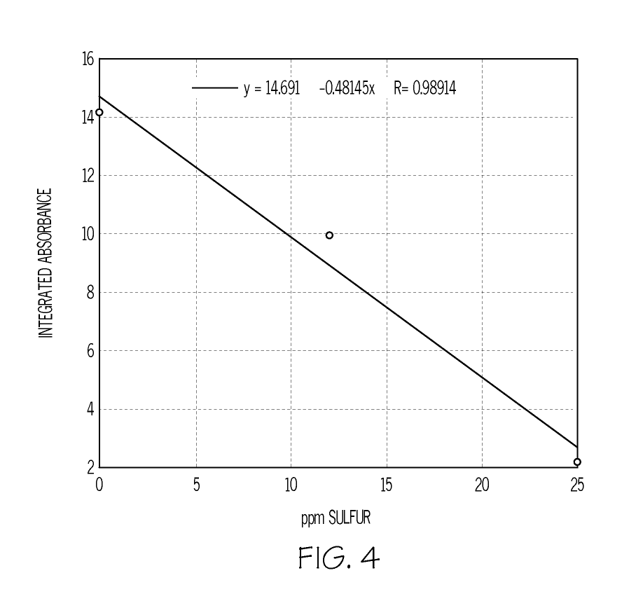

As a second test of the linearity of the absorbance vs. sulfur concentration relationship as well as the sensitivity of the test, the tests were repeated with 0, 12 and 25 ppm sulfur standards prepared in kerosene and dissolved in ethyl acetate (instead of acetone) containing 1% acetic acid. The tests were conducted using 5 mL glass vials with each vial containing 0.025 mL of 0.5% KMnO₄ in water, 3 mL of ethyl acetate containing 1% acetic acid and 0.25 mL of kerosene sulfur standard. Each vial was capped and hand shaken for 10 seconds (kerosene soluble in ethyl acetate). Color differences were visually noted after 30 seconds: 0 ppm sulfur standard solution had no color change; the 12 and 25 ppm sulfur standard solutions had lightened in color. The prepared solutions were then poured into a square, quartz cuvette for UV-VIS spectrophotometric analysis. Instead of using the absorbance reading of the peak at 528 nm, the area under the absorbance curve from 450-600 nm (FIG. 2) for each standard was integrated. The integrated absorbance versus sulfur concentration plot for the 0-25 ppm sulfur standards is shown in FIG. 4. As in FIG. 3, the integrated absorbance vs. sulfur concentration plot in FIG. 4 is linear and sensitive enough to distinguish between 0 and 6 ppm sulfur.

### EXAMPLE 3

As a third test of the sensitivity of the absorbance test, the tests were repeated with 0 and 25 ppm sulfur standards prepared in kerosene and suspended in water (instead of acetone) containing 0.1% phosphoric acid. The tests were conducted using 5 mL glass vials with each vial containing 0.025 mL of 0.5% KMnO₄ in water, 3 mL of distilled water containing 0.1% phosphoric acid and 0.25 mL of kerosene sulfur standard. Each vial was capped, hand shaken for 20 seconds (kerosene insoluble in water), allowed to sit for 20 seconds, then hand shaken for an additional 20 seconds. Color differences were visually noted after the additional 20 seconds of shaking: 0 ppm sulfur standard solution had no color change; the 25 ppm sulfur standard solutions had lightened in color, turning an orange-yellow color. The prepared solutions were allowed to sit for 2 minutes to allow the fuel to separate from the water layer. The clear water layer was then pipetted into a square quartz cuvette for UV-VIS spectrophotometric analysis.

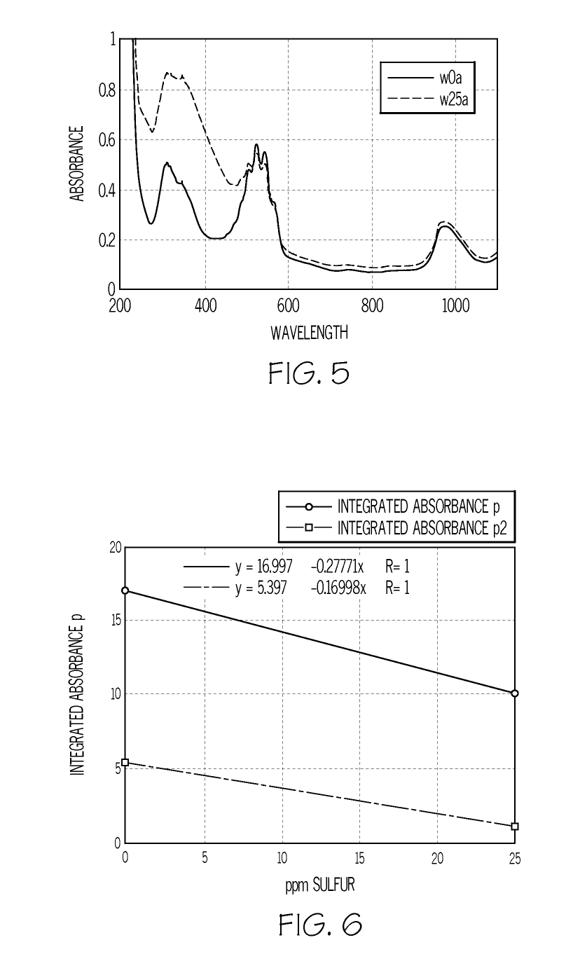

The UV-VIS spectrum in FIG. 5 shows that water has minimal absorbance above 250 nm (C═O in acetone which absorbs UV light, is not present in water), allowing the yellow peak at 320 nm to be quantitated. The yellow peak was similar in height for the 0 and 25 ppm standards, but the baseline was shifted higher by the colored product of the sulfur compound and KMnO₄.

The area under the absorbance curve from 450-600 nm (FIG. 5) for each standard was integrated due to the baseline shift caused by the yellow color developed by the 25 ppm standard. The integrated absorbance vs. sulfur concentration plots for the 0 and 25 sulfur standards are shown in FIG. 6. The integrated absorbance vs. sulfur concentration plots appear to be sensitive enough to distinguish between 0 and 6 ppm sulfur. The plots produced for the absorbances recorded after 2 and 20 minutes total shaking/sitting times indicate that the additional reaction time is of no benefit to the sensitivity of the test because the slope (sensitivity) is greater for the 2 minute reaction time (upper line) than the 20 minute time (lower line).

### EXAMPLE 4

To test the visual capabilities of the colorimetric test, the tests were repeated with 0 and 25 ppm sulfur standards prepared in kerosene and dissolved in acetone containing 0.1, 0.5 and 1% phosphoric acid. The tests were run in 15 mL glass test tubes with each tube containing 0.1 mL of 0.5% KMnO₄ in water, 10 mL of acetone and 3 mL of kerosene sulfur standard. Each tube was capped and hand shaken for 10 seconds (kerosene soluble in acetone with 0.1% phosphoric acid). After 30 seconds, the 0 ppm sulfur standard solutions were slightly lighter in color regardless of the acid concentration and the 25 ppm sulfur standard solutions were colorless for the 0.1% phosphoric acid solution with increasing yellow color as the acid content was increased in the solution to 1% (0 ppm standard solution with 1% acid had yellow hue compared to other solutions).

The tests were repeated with 0 and 25 ppm sulfur standards prepared in kerosene and suspended in distilled water containing 0.1, 0.5 and 1% phosphoric acid. The tests were run in 15 mL glass test tubes with each tube containing 0.1 mL of 0.5% KMnO₄ in water, 10 mL of water and 3 mL of kerosene sulfur standard. Each tube was capped and hand shaken for 30 seconds (kerosene insoluble in water regardless of phosphoric acid content). After 30 seconds of shaking and 1 minute of sitting to allow the fuel layer to separate, the 0 ppm sulfur standard solutions were darker in color regardless of the acid concentration. The 25 ppm sulfur standard solutions were slightly colored with the 0.1% phosphoric acid solution being slightly orange-yellow in color. The yellow hue of the 25 ppm samples decreased as the acid content in the solution was increased to 1% (opposite effect of acid compared to acetone tests). Foam present at the fuel layer:water layer interface in the 0.1% phosphoric acid solution indicates that the rate of fuel separation decreases as the phosphoric acid content decreases.

If an increased rate of fuel separation is desired, water soluble salts such as potassium acetate, potassium hydrogen phosphates, etc. can be used to increase the ionic strength of the water solution to decrease the solubility of the fuel in the water layer.

The tests were repeated with 6 ppm (ULSD) sulfur fuels and 400 ppm (non-ULSD) sulfur fuels and distilled water containing 1% phosphoric acid. The tests were conducted in 15 mL glass test tubes with each tube containing 0.3 mL of 0.5% KMnO₄ in water (increased KMnO₄ concentration due to 400 ppm sulfur levels of non-ULSD fuels), 10 mL of water and 3 mL of fuel. Each tube was capped and hand shaken for 30 seconds (fuels insoluble in water regardless of sulfur content). After 30 seconds of shaking and 1 minute of sitting (to allow fuel layer to separate), the 6 ppm ULSD fuel solutions were dark in color and the 400 ppm sulfur non-ULSD fuel solutions were colorless.

As a final test of the visual capability of the colorimetric test, the tests were repeated with 6 ppm (ULSD) sulfur fuels and 400 ppm (non-ULSD) sulfur fuels and acetone containing 0 and 1% phosphoric acid. The tests were conducted in 5 mL glass vials with each vial containing 0.1 mL of 0.5% KMnO₄ in water, 4 mL of acetone and 0.5 mL of fuel. Each vial was capped and hand shaken for 10 seconds (fuels soluble in acetone regardless of acid content). After 30 seconds, the 6 ppm ULSD fuel solutions were dark in color regardless of acid content while the 400 ppm sulfur non-ULSD fuel solution was colorless in the presence of acid and remained purple in the absence of acid. Thus, it can be concluded that the KMnO₄ must be acidic to react with the sulfur compounds in the fuels. Consequently, the neutral KMnO₄ test could be used to identify the presence of easily oxidizable non-sulfur compounds. In neutral solutions, easily oxidizable compounds (such as unsaturated compounds found in gasoline or produced by fuel oxidation during storage react with/decolorize KMnO₄). The KMnO₄ decolorization test could also be used to identify ULSD fuels contaminated by gasoline (2.5% contamination visually detectable) or oxidized by long term storage or misuse (severe oxidation confirmed by hydroperoxide measurements using ASTM Method D6447). Fuels that react with both neutral and acidic KMnO₄ are contaminated and/or oxidized. Fuels that react with only acidic KMnO₄ are fresh, non-contaminated fuels, non-ULSD (decolorize) or ULSD (lighten).

Additional tests with either acidic acetone or water indicated both visually and by UV-VIS spectrophotometer that the KMnO₄ test was capable of detecting ULSD fuels that were contaminated with 2.5% non-ULSD fuel (represents addition of 10 ppm sulfur to ULSD) and the relationship between non-ULSD fuel contamination and the KMnO₄ test was linear up to over 50% contamination (lower amount of fuel used to obtain linearity to 100% contamination, i.e., fuel is non-ULSD).

In both the acidic acetone and water KMnO₄ tests, the fuel:KMnO₄ ratio can be increased to quantitate the very low levels of sulfur (below 6 ppm) in ULSD fuels or the ratio can be decreased to quantitate the high levels of sulfur (above 400 ppm) in non-ULSD fuels and other sulfur containing organic liquids such as jet fuels (Jet A fuel can contain up to 2000 ppm sulfur).

In addition to using aqueous or solvent solutions containing the oxidizing agent, non-volatile oxidizing agents could be used without prior dilution. The required amount of dry oxidizing agent could be obtained by weighing on a precession balance (±5 μg) or by dispensing the required amount of solution and evaporating the solvent to produce the residue for use. The dry oxidizing agent could be encapsulated in a solvent soluble capsule, breakable glass capsules, etc.

In addition to the depletion of the purple color (450-600 nm in FIG. 2), the water KMnO₄ test can use the orange-yellow color produced by the KMnO₄:sulfur reaction as a secondary color to measure the presence of sulfur in ULSD fuels (yellow color of fuel does not interfere since it is insoluble in water). This test would be useful for fuels in which KMnO₄ depletion occurs due to non-sulfur, easily oxidizable compounds, i.e., KMnO₄ depletion due to oxidation of fuel components (orange-yellow color is only produced if oxidizable compounds contain sulfur).

Having described the embodiments of the invention in detail and by reference to preferred embodiments thereof, it will be apparent that modifications and variations are possible without departing from the scope of the disclosure.

What is claimed is:

1. A method of detecting the sulfur content in fuels comprising:
providing a fuel sample;
mixing said fuel sample with at least a solvent and an oxidizing agent; and
detecting a color change in said mixture.

2. The method of claim 1 wherein said fuel sample is selected from ultra low sulfur diesel fuel, non-ultra low sulfur diesel fuel, and contaminated low sulfur diesel fuel.

3. The method of claim 1 wherein said color change is determined by visual observation, a colorimeter, or a spectrophotometer.

4. The method of claim 1 further comprising quantifying said color change.

5. The method of claim 1 further comprising corresponding said color change with at least one of fuel contamination, oxidation, and sulfur content.

6. The method of claim 1 wherein said solvent is selected from acetone, water, acetonitrile, benzonitrile, ethyl acetate, alcohols, and ketones.

7. The method of claim 1 wherein said oxidizing agent is selected from potassium permanganate, sodium dichromate, nitric acid, hydrogen peroxide, cumene hydroperoxide, and sodium hypochlorite.

8. The method of claim 1 wherein said solvent is an acidified solvent.

9. The method of claim 8 wherein said solvent includes an acid selected from toluenesulfonic acid, phosphoric acid, acetic acid, or a combination thereof.

10. The method of claim 1 wherein said solvent is an acidified solvent, and further comprising corresponding said color change with at least one of fuel contamination, oxidation, and sulfur content.

11. The method of claim 1 wherein said solvent is a neutral solvent, and further comprising corresponding said color change with at least one of fuel contamination or oxidation.

12. A method of analyzing the sulfur content in fuels comprising:
providing a fuel sample;
mixing said fuel sample with at least a solvent and an oxidizing agent to form a mixture; and
determining whether a color change of said mixture has taken place to determine sulfur content in said fuel sample.

13. The method of claim 12 wherein said solvent is selected from acetone, water, acetonitrile, benzonitrile, ethyl acetate, alcohols, and ketones.

14. The method of claim 12 wherein said oxidizing agent is selected from potassium permanganate, sodium dichromate, nitric acid, hydrogen peroxide, cumene hydroperoxide, and sodium hypochlorite.

15. The method of claim 12 wherein said oxidizing agent comprises potassium permanganate.

16. The method of claim 12 wherein said solvent further includes an acid selected from toluenesulfonic acid, phosphoric acid, acetic acid, or a combination thereof.

17. The method of claim 12 wherein said fuel sample is selected from ultra low sulfur diesel fuel, non-ultra low sulfur diesel fuel, and contaminated low sulfur diesel fuel.

18. The method of claim 12 wherein said color change is determined by visual observation, a calorimeter, or a spectrophotometer.

19. The method of claim 18 wherein said visual observation includes comparison with a standard colored solution or standardized color chart.

20. A method of analyzing the sulfur content in fuels comprising:
providing a fuel sample;
providing an amount of an oxidizing agent comprising KMnO₄;
adding said oxidizing agent to an acidified solvent to form a mixture;
adding said fuel sample to said mixture to form a reaction product; and
determining whether a color change of said reaction product has taken place to determine sulfur content in said fuel sample.
